(19) United States
(12) Patent Application Publication
(10) Pub. No.: US 2025/0269806 A1
(43) Pub. Date: Aug. 28, 2025

(54) FLOOR WIRING MODULE, FLOOR STACKED BODY, AND METHOD OF MANUFACTURING FLOOR WIRING MODULE

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Yuta TOME, Osaka (JP); Housei MIZUNO, Osaka (JP); Takeshi KOIDE, Osaka (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 18/857,261

(22) PCT Filed: Apr. 17, 2023
(86) PCT No.: PCT/JP2023/015375

§ 371 Date: Oct. 16, 2024

(30) Foreign Application Priority Data
Apr. 25, 2022 (JP) 2022-071467

(51) Int. Cl. B60R 13/02; H02G 3/04; H02G 3/30

(52) U.S. Cl. CPC B60R 13/02; H02G 3/0406; H02G 3/30

(57) ABSTRACT

A floor wiring module includes a silencer, a carpet stacked on one main surface of the silencer, and a wiring member sandwiched and held between the silencer and the carpet. A stacked region where the silencer and the carpet are stacked includes a first region where the silencer and the carpet are thermally pressed and fixed to each other and a second region, adjacent to the first region on one main surface, where the wiring member is located between the silencer and the carpet.

### TECHNICAL FIELD

The present disclosure relates to a floor wiring module, a floor stacked body, and a method of manufacturing a floor wiring module.

### BACKGROUND ART

Patent Document 1 discloses an electrical wire routing structure in a floor panel of a vehicle. The electrical wire routing structure in Patent Document 1 has a feature that it includes a housing concave part provided to an inner surface of a vehicle interior of the floor panel, an electrical wire housed in the housing concave part, and a holding member housing and holding the electrical wire in the housing concave part.

### PRIOR ART DOCUMENTS

### Patent Document(s)

Patent Document 1: Japanese Patent Application Laid-Open No. 2019-089398

### SUMMARY

### Problem to be Solved by the Invention

A silencer and a carpet, for example, are disposed in addition to the electrical wire

to the floor panel in some cases. It is desired that the silencer and the carpet can be simply disposed to the floor panel.

Accordingly, an object is to provide a technique capable of simply locating a silencer and a carpet on a floor panel.

### Means to Solve the Problem

A floor wiring module according to the present disclosure is a floor wiring module including: a silencer; a carpet stacked on one main surface of the silencer; and a wiring member sandwiched and held between the silencer and the carpet, wherein a stacked region where the silencer and the carpet are stacked includes a first region where the silencer and the carpet are thermally pressed and fixed to each other and a second region, adjacent to the first region on the one main surface, where the wiring member is located between the silencer and the carpet.

### Effects of the Invention

According to the present disclosure, the silencer and the carpet can be simply disposed on the floor panel.

### BRIEF DESCRIPTION OF DRAWINGS

FIG. 1 is a plan view illustrating a floor wiring module according to an embodiment 1.

FIG. 2 is a cross-sectional view along a II-II line in FIG. 1.

FIG. 3 is a perspective view illustrating a method of manufacturing the floor wiring module.

FIG. 4 is a perspective view illustrating a method of manufacturing the floor wiring module.

FIG. 5 is a perspective view illustrating a method of manufacturing the floor wiring module.

### DESCRIPTION OF EMBODIMENT(S)

### Description of Embodiments of Present Disclosure

Embodiments of the present disclosure are listed and described firstly.

A floor wiring module according to the present disclosure is as follows.
(1) A floor wiring module includes: a silencer; a carpet stacked on one main surface of the silencer; and a wiring member sandwiched and held between the silencer and the carpet, wherein a stacked region where the silencer and the carpet are stacked includes a first region where the silencer and the carpet are thermally pressed and fixed to each other and a second region, adjacent to the first region on the one main surface, where the wiring member is located between the silencer and the carpet.

According to such a floor wiring module, the silencer and the carpet are thermally pressed and fixed to each other in the first region, thus can be firmly fixed by relatively high fixing force. Accordingly, the silencer and the carpet are kept in an integrated state in the floor wiring module, thus can be simply disposed on a floor panel. The second region adjacent to the first region is an arrangement region where the wiring member is arranged, thus the wiring member can be simply disposed on a stacked body of the silencer and the carpet, and the thermal press in the first region hardly has influence on the wiring member.
(2) In the floor wiring module according to (1), the stacked region may include a third region, adjacent to the second region on the one main surface, where the silencer and the carpet are fixed to each other via a mechanical bonding member. Accordingly, the third region can be simply provided. The first region, the second region, and the third region can be provided in this order, and the thermal press in the first region hardly has influence on the wiring member.
(3) In the floor wiring module according to (2), an area of the first region may be larger than an area of the third region in the one main surface. Accordingly, the silencer and the carpet are easily kept in the integrated state.
(4) In the floor wiring module according to (2) or (3), the first region may be disposed in a region which a passenger steps on more likely than the second region and the third region in a floor of a vehicle. Accordingly, the passenger hardly steps on the wiring member in the second region and the mechanical bonding member in the third region. The silencer and the carpet are fixed to each other by the thermal press in the first region, thus strength against stepping of the passenger can be easily obtained.
(5) In the floor wiring module according to any one of (1) to (4), a wiring holding part fixing the wiring member to at least one of the silencer and/or the carpet may be provided to the second region. Accordingly, a positional deviation between the wiring member and the stacked body of the silencer and the carpet is suppressed.
(6) In the floor wiring module according to (5), the wiring holding part may be a holding part including a mechanical bonding member or a bonding holding part having smaller fixing force than fixing force between the silencer and the carpet in the first region. Accordingly, even in a case where the wiring member needs to be detached from the stacked body of the silencer and the carpet in repairing the floor wiring module, the wiring member is easily detached.
(7) In the floor wiring module according to any one of (1) to (6), it is applicable that the carpet includes a window part located in a region on an inner side than an outer edge of the one main surface of the silencer, and the wiring member includes an end portion extending onto the carpet through the window part. Accordingly, the wiring member can be easily connected to an apparatus located in the region on the inner side than the outer edge of one main surface of the silencer.
(8) A floor stacked body according to the present disclosure is a floor stacked body including: a silencer; and a carpet stacked on one main surface of the silencer, wherein a stacked region where the silencer and the carpet are stacked includes a fixation region where the silencer and the carpet are thermally pressed and fixed to each other and a separation region, adjacent to the fixation region on the one main surface, where the silencer and the carpet are separated from each other.

According to such a floor stacked body, the silencer and the carpet are thermally pressed and fixed to each other in the fixation region, thus can be firmly fixed by relatively high fixing force. Accordingly, the silencer and the carpet are kept in an integrated state in the floor wiring module, thus can be simply disposed on a floor panel. The silencer and the carpet are separated from each other in the separation region different from the fixation region, thus the wiring member can be easily disposed between the silencer and the carpet.
(9) A method of manufacturing a floor wiring module according to the present disclosure is a method of manufacturing a floor wiring module including: thermally pressing and fixing a part of a stacked region where a silencer and a carpet are stacked; and locating a wiring member between the silencer and the carpet in another part of the stacked region where the silencer and the carpet are not fixed to each other.

According to such a method of manufacturing the floor wiring module, the silencer and the carpet are thermally pressed and fixed to each other in a part of the stacked region, thus can be firmly fixed by relatively high fixing force. Accordingly, the silencer and the carpet are kept in an integrated state in the floor wiring module, thus can be simply disposed on a floor panel. The wiring member is disposed in the region different from the region where the silencer and the carpet are thermally pressed and fixed to each other, thus the thermal press for fixing the silencer and the carpet hardly has influence on the wiring member.

### Detailed Description of Embodiment of Present Disclosure

Described hereinafter with reference to the diagrams are specific examples of a floor wiring module, a floor stacked body, and a method of manufacturing a floor wiring module according to the present disclosure. The present disclosure is not limited to these examples, but is indicated by claims, and it is intended that meanings equivalent to claims and all modifications within a scope of claims are included.

### Embodiment 1

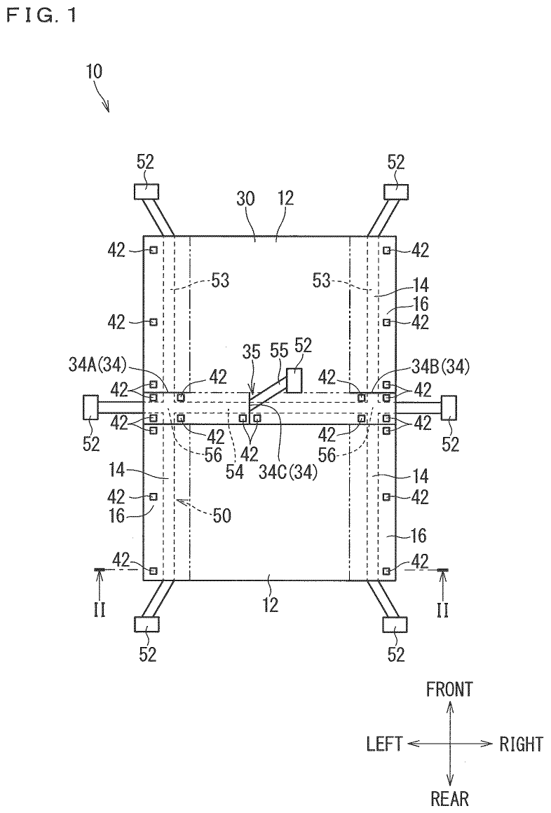

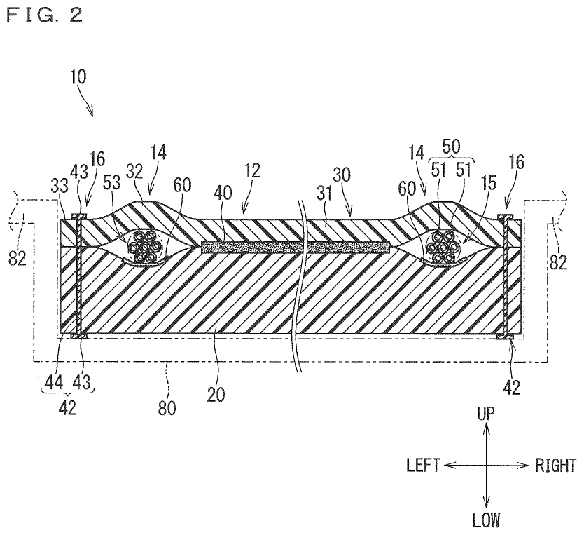

Described hereinafter are a floor wiring module 10, a floor stacked body 100, and a method of manufacturing the floor wiring module 10 according to an embodiment 1. FIG. 1 is a plan view illustrating the floor wiring module 10 according to the embodiment 1. FIG. 2 is a cross-sectional view along a II-II line in FIG. 1. A front-back direction (FRONT, REAR), a right-left direction (RIGHT, LEFT), and an up-down direction (UP, LOW) illustrated in FIG. 1 and FIG. 2 correspond to a front-back direction, a right-left direction, and an up-down direction in a vehicle, respectively.

The floor wiring module 10 is disposed on a floor panel 80 in the vehicle. The floor panel 80 is disposed on a lower part of a vehicle interior. The floor panel 80 is a metal floor plate, for example. The floor wiring module 10 includes a silencer 20, a carpet 30, and a wiring member 50.

The silencer 20 is a soundproof member disposed on the floor panel 80. The silencer 20 may be a member flattening unevenness of the floor panel 80, for example. The silencer 20 is a mold body made of fibers or foam resin as a material, for example. The silencer 20 may be thicker than the carpet 30. It is applicable that the silencer 20 has higher rigidity than the carpet 30 and can keep a form.

The carpet 30 is disposed on the silencer 20. The carpet 30 is normally exposed to the vehicle interior as a design surface. It is applicable that the carpet 30 has lower rigidity than the silencer 20 and can be easily bended. The carpet 30 is stacked on one main surface of the silencer 20. The wiring member 50 is sandwiched and held between the silencer 20 and the carpet 30. Herein, the carpet 30 is divided in a front-back direction of the vehicle.

The wiring member 50 connects apparatuses to each other in the vehicle. The wiring member 50 includes a plurality of wire-like transmission members 51. The wire-like transmission member 51 may be an electrical wire transmitting electricity or an optical fiber cable transmitting light. The plurality of wire-like transmission members 51 may be bundled in accordance with each route in the vehicle. The plurality of wire-like transmission members 51 may be bundled by an adhesive tape or a banding member such as a banding band.

Herein, a connector 52 is provided to an end portion of the wire-like transmission member 51. The wire-like transmission member 51 is connected to an apparatus or the other wiring member 50 via the connector 52. The connector 52 includes a terminal of the connector 52 and a housing of the connector 52. The end portion of the wire-like transmission member 51 is connected to the terminal of the connector 52. The terminal of the connector 52 is positioned and held in the housing of the connector 52. The end portion of the wire-like transmission member 51 may be directly connected to an apparatus, for example, without an intervention of the connector 52.

Herein, the wiring member 50 includes a first extension part 53, a second extension part 54, and a third extension part 55.

The first extension part 53 extends along the front-back direction of the vehicle. Herein, a pair of first extension parts 53 are provided. The pair of first extension parts 53 are separated from each other in a width direction of the vehicle. One of the pair of first extension parts 53 extends along a left lateral edge part of the silencer 20, and the other one of the pair of first extension parts 53 extends along a right lateral edge part of the silencer 20. A front end portion of the first extension part 53 extends from a front end of the silencer 20 to be located closer to a front side of the vehicle than the silencer 20. A back end portion of the first extension part 53 extends from a back end of the silencer 20 to be located closer to a back side of the vehicle than the silencer 20.

The second extension part 54 extends along the width direction of the vehicle. The second extension part 54 is disposed in an intermediate part of the silencer 20 along an extension direction of the first extension part 53. A joint part of the first extension part 53 and the second extension part 54 is a branch part 56. A left end portion of the second extension part 54 extends from a left end of the silencer 20 to be located closer to a left side of the vehicle than the silencer 20. A right end portion of the second extension part 54 extends from a right end of the silencer 20 to be located closer to a right side of the vehicle than the silencer 20.

The third extension part 55 is branched from an intermediate part along an extension direction of the second extension part 54. The branch part 56 of the second extension part 54 and the third extension part 55 is provided between the pair of first extension parts 53.

A stacked region where the silencer 20 and the carpet 30 are stacked includes a first region 12, a second region 14, and a third region 16.

The first region 12 is a region where the silencer 20 and the carpet 30 are thermally pressed and fixed to each other. Herein, a thermal gluing agent 40 is provided between the silencer 20 and the carpet 30. The silencer 20 and the carpet 30 are firmly fixed to each other via the thermal gluing agent 40.

The second region 14 is located adjacent to the first region 12 on one main surface of the silencer 20. A dash-double-dot line in FIG. 1 indicates a boundary between the first region 12 and the second region 14. The second region 14 is a region where the wiring member 50 is located between the silencer 20 and the carpet 30. The wiring member 50 is located between the silencer 20 and the carpet 30 in the second region 14, thus at least one of the silencer 20 and/or the carpet 30 may be bowed or bended by a thickness of the wiring member 50. In the example illustrated in FIG. 2, the silencer 20 is bowed, and the carpet 30 is bended. It is also applicable that a groove is provided to the silencer 20 so that the carpet 30 is not bended.

Provided to the second region 14 is a wiring holding part 15 fixing the wiring member 50 to at least one of the silencer 20 and/or the carpet 30. The wiring holding part 15 is a holding part including a mechanical bonding member or a bonding holding part having smaller fixing force than fixing force between the silencer 20 and the carpet 30 in the first region 12.

When the wiring holding part 15 is the holding part including the mechanical bonding member, the mechanical bonding member may be an elastic member such as sponge. When the elastic member is sandwiched and compressed between the wiring member 50 and the silencer 20 or the carpet 30, friction force occurs, and the wiring member 50 is held by the friction force.

When the wiring holding part 15 is the bonding holding part having smaller fixing force than fixing force between the silencer 20 and the carpet 30 in the first region 12, the bonding holding part may be a single-sided adhesive tape, a double-sided adhesive tape, or a part bonded using an adhesive member such as an adhesive agent. The bonding holding part may be a part in which resin of at least one of the wiring member 50 and/or the silencer 20 or the carpet 30 is melted and bonded to a counterpart member such as fusion without an intervention of the other member. FIG. 2 illustrates an example of the bonding holding part including the adhesive member 60 such as a double-sided adhesive tape or an adhesive agent as the wiring holding part 15.

The wiring holding part 15 may be provided to a plurality of positions at intervals along the extension direction of the wiring member 50 on the silencer 20. In this case, it is sufficient that the wiring holding part 15 is provided to a part where the wiring member 50 extends from the silencer 20 or the branch part 56 of the wiring member 50, for example. The wiring holding part 15 may be provided to a whole position along the extension direction of the wiring member 50 on the silencer 20.

The third region 16 is located adjacent to the second region 14 on one main surface of the silencer 20. The third region 16 is a region where the silencer 20 and the carpet 30 are fixed to each other via a mechanical bonding member 42. The mechanical bonding member 42 is not particularly limited, but may be a tag-pin-like member, a stapler, or a sewing thread, for example. The third region 16 includes an outer edge of the carpet 30. The third region 16 is connected to the first region 12 via the second region 14. The second region 14 intervenes between the first region 12 and the third region 16. Each of the second region 14 and the third region 16 has a free end before the third region 16 is fixed.

FIG. 2 illustrates an example of a tag pin-like member 42 as the mechanical bonding member 42. The tag pin-like member 42 includes a pair of support pieces 43 and a connection piece 44 connecting the pair of support pieces 43, for example. One of the pair of support pieces 43 is located on a lower side of a lower surface of the silencer 20 and caught on the lower surface of the silencer 20. The other one of the pair of support pieces 43 is located on an upper side of an upper surface of the carpet 30 and caught on the upper surface of the carpet 30. The connection piece 44 passes through the silencer 20 and the carpet 30.

An area of the first region 12 is larger than that of the third region 16 in one main surface of the silencer 20. The area of the first region 12 may be larger than that of the second region 14. The area of the first region 12 may be larger than a sum of the area of the second region 14 and the area of the third region 16. Half or more of an area of one main surface of the silencer 20 may be the first region 12.

The first region 12 is disposed in a region which a passenger steps on more likely than the second region 14 and the third region 16 in a floor of the vehicle. The region which the passenger steps on likely is an area around feet of the passenger, for example. A region which the passenger hardly steps on is a lower side of a seat or a lateral side of a rocker 82, for example.

In the carpet 30, a part constituting the first region 12 is a first fixation part 31, a part constituting the second region 14 is a wiring covering part 32, and a part constituting the third region 16 is a second fixation part 33. The wiring covering part 32 is connected to a left side, a right side, and a back side of the first fixation part 31 of the carpet 30 located on a front side of the vehicle. The wiring covering part 32 on the left side and the wiring covering part 32 on the back side are separated from each other via a slit 34A. The wiring covering part 32 on the right side and the wiring covering part 32 on the back side are separated from each other via a slit 34B. The wiring covering part 32 on the back side is separated to right and left sides via a slit 34C. The tag pin-like member 42 is provided to four positions around the branch part 56 in a part of the wiring covering part 32 on the back side covering the branch part 56 of the first extension part 53 and the second extension part 54. The wiring covering part 32 is connected to the left side and the right side of the first fixation part 31 of the carpet 30 located on a back side of the vehicle.

The carpet 30 includes a window part 35 located in a region on an inner side than an outer edge of one main surface of the silencer 20. The wiring member 50 includes an end portion extending onto the carpet 30 through the window part 35. Herein, the end portion of the third extension part 55 extends onto the carpet 30 through the window part 35. The end portion of the third extension part 55 is connected to an apparatus on the carpet 30. The apparatus may be an apparatus disposed on a seat.

### <Manufacturing Method>

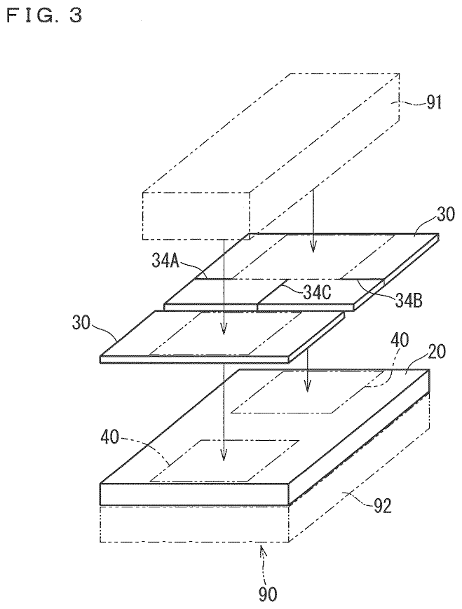

A method of manufacturing the floor wiring module 10 is described next with reference to FIG. 3 to FIG. 5. FIG. 3 to FIG. 5 are perspective views each illustrating the method of manufacturing the floor wiring module 10.

Firstly, as illustrated in FIG. 3, a part of the stacked region of the silencer 20 and the carpet 30 are thermally pressed and fixed to each other. The carpet 30 is divided into two pieces along the front-back direction. The slit 34 is formed in the carpet 30 on a front side. The region thermally pressed in the carpet 30 is a region surrounded by a dash-double-dot line in FIG. 3. The carpet 30 on the front side and the carpet 30 on a back side are separated in the front-back direction in FIG. 3. The carpet 30 on the front side and the carpet 30 on the back side may have contact with each other in the front-back direction.

The thermal press is performed using a thermal press apparatus 90. The thermal press apparatus 90 includes a pair of press members 91 and 92. The press member 91 presses the carpet 30, and the press member 92 presses the silencer 20. For example, the thermal press is performed while at least one of the pair of press members 91 and 92 is heated by a heating apparatus.

The thermal gluing agent 40 is provided to a part of the silencer 20 and the carpet 30 to be firmly fixed to each other. A part where the thermal gluing agent 40 is provided is thermally pressed, thus the silencer 20 and the carpet 30 are firmly fixed to each other via the thermal gluing agent 40. A part where the thermal gluing agent 40 is not provided in the silencer 20 and the carpet 30 may also be thermally pressed. In this case, the part where the thermal gluing agent 40 is not provided in the silencer 20 and the carpet 30 may not be firmly fixed when the thermal press is performed.

Next, the wiring member 50 is disposed between the silencer 20 and the carpet 30 in the other part of the stacked region of the silencer 20 and the carpet 30 where the silencer 20 and the carpet 30 are not fixed to each other.

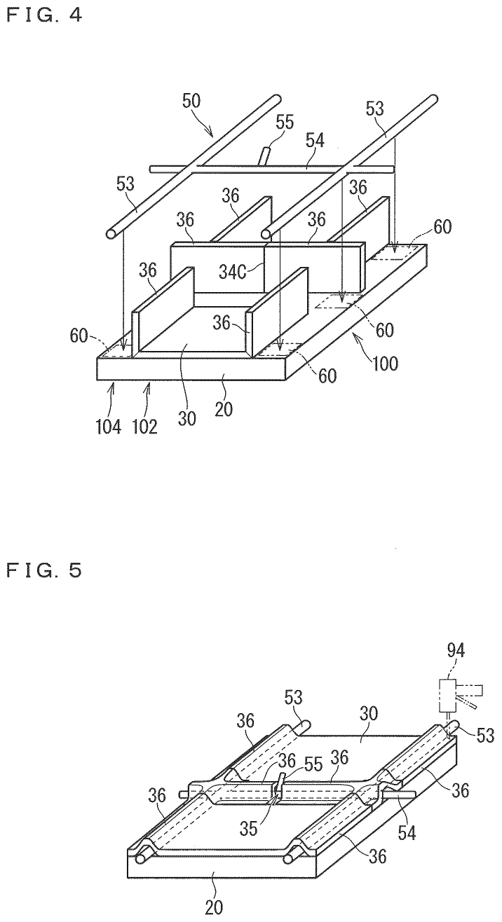

Herein, as illustrated in FIG. 4, a part of the stacked region of the silencer 20 and the carpet 30 fixed by thermal pressing is the floor stacked body 100. The floor stacked body 100 includes the silencer 20 and the carpet 30 stacked on one main surface of the silencer 20. The stacked region of the silencer 20 and the carpet 30 includes a fixation region 102 and a separation region 104 in the floor stacked body 100. The fixation region 102 is a region where the silencer 20 and the carpet 30 are thermally pressed and fixed to each other. The fixation region 102 corresponds to the first region 12 in the floor wiring module 10. The separation region 104 is located adjacent to the fixation region 102 on one main surface of the silencer 20. The separation region 104 is a region where the silencer 20 and the carpet 30 are separated from each other. The separation region 104 is a part serving as the second region 14 and the third region 16 in the floor wiring module 10.

A part closer to a distal portion in relation to a base end portion connected to the fixation region 102 in a part constituting the separation region 104 in the carpet 30 constituting the floor stacked body 100 serves as a movable piece 36 which is freely movable around the base end portion. The movable piece 36 can be bended at the base end portion as a folding line connected to the fixation region 102. The slits 34A, 34B, and 34C are provided to the carpet 30 on the front side of the vehicle, thus four movable pieces 36 are provided to a left side, a right side, a back left side, and a back right side in the fixation region 102, respectively. The movable pieces 36 are provided to a right side and a left side in the fixation region 102 in the carpet 30 on the back side of the vehicle.

The wiring member 50 is disposed between the silencer 20 and the carpet 30 in the separation region 104 in the floor stacked body 100.

Firstly, as illustrated in FIG. 4, the movable piece 36 is bended to expose the upper surface of the silencer 20. Then, the wiring member 50 is disposed on the upper surface of the exposed silencer 20. At this time, the upper surface of the silencer 20 exposed by bending all of the movable pieces 36 has a shape corresponding to a route of the wiring member 50. The wiring member 50 is disposed on the upper surface of the exposed silencer 20, thus the wiring member 50 can be easily disposed along a predetermined route. In the example illustrated in FIG. 4, the movable piece 36 is bended at 90 degrees. It is also applicable to bend the movable piece 36 at 180 degrees to be overlapped with the fixation region 102. The carpet 30 may be formed to be able to bend the movable piece 36 so that the movable piece 36 is overlapped with the fixation region 102.

In FIG. 4, the adhesive member 60 such as a double-sided adhesive tape or an adhesive agent is provided to the upper surface of the silencer 20. The wiring member 50 is disposed on the upper surface of the silencer 20, and the adhesive member 60 is bonded to the silencer 20 and the wiring member 50, thus the wiring holding part 15 described above is formed.

After the wiring member 50 is disposed on the upper surface of the exposed silencer 20, the movable piece 36 is returned to an initial state. In the carpet 30 on the front side in two carpets 30, the movable piece 36 located closer to a back side than the fixation region 102 may or may not have contact with the carpet 30 on the back side in two carpets 30. At this time, the end portion of the first extension part 53 and the end portion of the second extension part 54 are led to an outer side of the silencer 20 herein. The third extension part 55 is led onto the carpet 30 from between two movable pieces 36 separated from each other by the slit 34C. A space between two movable pieces 36 serves as the window part 35 described above. Accordingly, the wiring member 50 is disposed between the silencer 20 and the carpet 30, and is in a state illustrated in FIG. 5. It is sufficient that the window part 35 can lead out a part of the wiring member 50. For example, it is applicable that parts of two movable pieces 36 in front of the wiring member 50 and parts thereof in back of the wiring member 50 have contact in the right-left direction, thus the window part 35 has a slit-like shape. For example, it is applicable that two movable pieces 36 are separated in the right-left direction, thus the window part 35 has an opening-like shape.

Next, the silencer 20 and the carpet 30 are fixed to each other on a lateral side of the wiring member 50 in the separation region 104. FIG. 5 illustrates an example of knocking in the tag pin-like member 42 using a jig 94 to fix the silencer 20 and the carpet 30 to each other. The tag pin-like member 42 is fixed to a tip of the movable piece 36 on a side opposite to the fixation region 102. The silencer 20 and the carpet 30 are fixed to each other via the tag pin-like member 42 in a predetermined position in the stacked region to manufacture the floor wiring module 10 described above.

It is also applicable that a product as the floor wiring module 10 is transported to an assembly plant where the floor wiring module 10 is to be assembled to a vehicle and disposed on the floor panel 80. It is also applicable that the floor stacked body 100 is transported to an assembly plant where the floor stacked body 100 is to be assembled to a vehicle and disposed on the floor panel 80, and the wiring member 50 is disposed on the floor stacked body 100 on the floor panel 80 to constitute the floor wiring module 10.

### <Effect Etc.>

According to the floor wiring module 10 having the configuration described above, the silencer 20 and the carpet 30 are thermally pressed and fixed to each other in the first region 12, thus can be firmly fixed by relatively high fixing force. Accordingly, the silencer 20 and the carpet 30 are easily kept in an integrated state in the floor wiring module 10, thus can be simply disposed on the floor panel 80. The second region 14 adjacent to the first region 12 is the arrangement region where the wiring member 50 is arranged, thus the wiring member 50 can be simply disposed on the stacked body of the silencer 20 and the carpet 30, and the thermal press in the first region 12 hardly has influence on the wiring member 50.

The stacked region includes the third region 16, adjacent to the second region 14 on one main surface of the silencer 20, where the silencer 20 and the carpet 30 are fixed to each other via the mechanical bonding member 42. Accordingly, the third region 16 can be simply provided. The first region 12, the second region 14, and the third region 16 can be provided in this order, and the thermal press in the first region 12 hardly has influence on the wiring member 50.

The area of the first region 12 is larger than that of the third region 16 in one main surface of the silencer 20. The area of the first region 12 where the silencer 20 and the carpet 30 are fixed to each other by thermal press is large, thus the silencer 20 and the carpet 30 are easily kept in the integrated state.

The first region 12 is disposed in the region which a passenger steps on more likely than the second region 14 and the third region 16 in the floor of the vehicle. Accordingly, the passenger hardly steps on the wiring member 50 in the second region 14 and the mechanical bonding member 42 in the third region 16. The silencer 20 and the carpet 30 are fixed to each other by the thermal press in the first region 12, thus strength against stepping of the passenger can be easily obtained.

Provided to the second region 14 is the wiring holding part 15 fixing the wiring member 50 to at least one of the silencer 20 and/or the carpet 30. Accordingly, a positional deviation between the wiring member 50 and the stacked body of the silencer 20 and the carpet 30 is suppressed.

The wiring holding part 15 is the holding part including the mechanical bonding member or the bonding holding part having smaller fixing force than fixing force between the silencer 20 and the carpet 30 in the first region 12. Accordingly, even in a case where the wiring member 50 needs to be detached from the stacked body of the silencer 20 and the carpet 30 in repairing the floor wiring module 10, the wiring member 50 is easily detached.

The carpet 30 includes the window part 35 located in the region on the inner side than the outer edge of one main surface of the silencer 20, and the wiring member 50 includes the end portion extending onto the carpet 30 through the window part 35. Accordingly, the wiring member 50 can be easily connected to the apparatus located in the region on the inner side than the outer edge of one main surface of the silencer 20.

According to the floor stacked body 100, the silencer 20 and the carpet 30 are thermally pressed and fixed to each other in the fixation region 102, thus can be firmly fixed by relatively high fixing force. Accordingly, the silencer 20 and the carpet 30 are easily kept in the integrated state in the floor wiring module 10, thus can be simply disposed on the floor panel 80. The silencer 20 and the carpet 30 are separated from each other in the separation region 104 different from the fixation region 102, thus the wiring member 50 can be easily disposed between the silencer 20 and the carpet 30.

According to the method of manufacturing the floor wiring module 10, the silencer 20 and the carpet 30 are thermally pressed and fixed to each other in a part of the stacked region, thus can be firmly fixed by relatively high fixing force. Accordingly, the silencer 20 and the carpet 30 are easily kept in the integrated state in the floor wiring module 10, thus can be simply disposed on the floor panel 80. The wiring member 50 is disposed in the region different from the region where the silencer 20 and the carpet 30 are thermally pressed and fixed to each other, thus the thermal press for fixing the silencer 20 and the carpet 30 hardly has influence on the wiring member 50.

### Appendix

In the above description, the stacked region includes the third region 16, however, this configuration is not necessary. The stacked region may not include the third region 16. For example, the movable piece 36 of the carpet 30 may remain unfixed in the vehicle. For example, it is also applicable that the movable piece 36 of the carpet 30 is fixed to a member other than the silencer 20 in the vehicle, and kept is a state where the silencer 20 and the carpet 30 sandwich the wiring member 50.

In the above description, the wiring holding part 15 is provided to the second region 14, however, this configuration is not necessary. For example, the wiring holding part 15 may not be provided to the second region 14.

In the above description, the wiring member 50 includes the end portion extending onto the carpet 30 through the window part 35, however, this configuration is not necessary. However, the wiring member 50 may not include the third extension part 55. The window part 35 needs not be the slit 34, but may also be a hole passing through the carpet 30.

In the above description, the carpet 30 is divided into the plurality of pieces, and the silencer 20 has the size corresponding to the size of the divided body of the plurality of carpets 30 integrated with each other, however, this configuration is not necessary. For example, it is also applicable that the silencer is divided into the plurality of pieces, and the carpet has a size corresponding to a size of a divided body of a plurality of silencers integrated with each other.

The configurations described in the embodiments and modification examples thereof can be appropriately combined as long as they are not contradictory.

### EXPLANATION OF REFERENCE SIGNS

10 floor wiring module
12 first region
14 second region
15 wiring holding part
16 third region
20 silencer
30 carpet
31 first fixation part
32 wiring covering part
33 second fixation part
34, 34A, 34B, 34C slit
35 window part
36 movable piece
40 thermal gluing agent
42 tag pin-like member (mechanical bonding member)
43 support piece
44 connection piece
50 wiring member
51 wire-like transmission member
52 connector
53 first extension part
54 second extension part
55 third extension part
56 branch part
60 adhesive member
80 floor panel
82 rocker
90 thermal press apparatus
91, 92 press member
100 floor stacked body
102 fixation region
104 separation region

1. A floor wiring module, comprising:
a silencer;
a carpet stacked on one main surface of the silencer; and
a wiring member sandwiched and held between the silencer and the carpet, wherein
a stacked region where the silencer and the carpet are stacked includes a first region where the silencer and the carpet are thermally pressed and fixed to each other and a second region, adjacent to the first region on the one main surface, where the wiring member is located between the silencer and the carpet.

2. The floor wiring module according to claim 1, wherein
the stacked region includes a third region, adjacent to the second region on the one main surface, where the silencer and the carpet are fixed to each other via a mechanical bonding member.

3. The floor wiring module according to claim 2, wherein
an area of the first region is larger than an area of the third region in the one main surface.

4. The floor wiring module according to claim 2, wherein
the first region is disposed in a region which a passenger steps on more likely than the second region and the third region in a floor of a vehicle.

5. The floor wiring module according to claim 1, wherein
a wiring holding part fixing the wiring member to at least one of the silencer and/or the carpet is provided to the second region.

6. The floor wiring module according to claim 5, wherein
the wiring holding part is a holding part including a mechanical bonding member or a bonding holding part having smaller fixing force than fixing force between the silencer and the carpet in the first region.

7. The floor wiring module according to claim 1, wherein
the carpet includes a window part located in a region on an inner side than an outer edge of the one main surface of the silencer, and
the wiring member includes an end portion extending onto the carpet through the window part.

8. A floor stacked body, comprising:
a silencer; and
a carpet stacked on one main surface of the silencer, wherein
a stacked region where the silencer and the carpet are stacked includes a fixation region where the silencer and the carpet are thermally pressed and fixed to each other and a separation region, adjacent to the fixation region on the one main surface, where the silencer and the carpet are separated from each other.

9. A method of manufacturing a floor wiring module, comprising:
thermally pressing and fixing a part of a stacked region where a silencer and a carpet are stacked; and
locating a wiring member between the silencer and the carpet in another part of the stacked region where the silencer and the carpet are not fixed to each other.
